(19) United States
(12) Patent Application Publication
(10) Pub. No.: US 2014/0300242 A1
(43) Pub. Date: Oct. 9, 2014

(54) BRUSHLESS MOTOR

(71) Applicant: AISAN KOGYO KABUSHIKI KAISHA, Obu-shi (JP)

(72) Inventor: Yoshihiko Honda, Obu-shi (JP)

(73) Assignee: AISAN KOGYO KABUSHIKI KAISHA, Obu-shi (JP)

(21) Appl. No.: 14/246,252

(22) Filed: Apr. 7, 2014

(30) Foreign Application Priority Data
Apr. 8, 2013 (JP) 2013-080424

(51) Int. Cl. H02K 1/14

(52) U.S. Cl. CPC H02K 1/148
USPC 310/216.009

(57) ABSTRACT

A brushless motor may comprise a stator. The stator may comprise a core body comprising a plurality of partial cores and a coil wire. Each partial core may comprise a yoke positioned on an outer edge of the stator, teeth extending towards a rotor from the yoke, and a connector extending to an adjacent partial core from the yoke, to be connected to the yoke of the adjacent partial core. The stator may be formed to be in a tubular state by being transformed from an opened state. Each of the yokes of the partial cores may comprise a facing surface facing the yoke of the adjacent partial core. At least one set of the facing surfaces among a plurality of sets of the facing surfaces facing each other may be disposed with a gap in between in the circumferential direction of the stator.

### CROSS-REFERENCE TO RELATED APPLICATION

This application claims priority to Japanese Patent Application No. 2013-80424 filed on Apr. 8, 2013, the contents of which are hereby incorporated by reference into the present application.

1. Technical Field

The present application discloses a brushless motor.

2. Description of Related Art

Japanese Patent Application Publication No. 2008-92691 discloses a rotating electric machine provided with a stator. The stator includes a laminated core. The laminated core includes a plurality of pole pieces that is connected with each other by connectors and linearly arranged. The stator is formed by bending the laminated core linearly arranged into a tubular shape. In the stator formed into the tubular shape, an end surface of a back yoke of each pole piece is in contact with the end surface of the back yoke of an adjacent pole piece.

### SUMMARY

In an above-described technique, when a length of the laminated core having the pole pieces linearly arranged varies among products, the end surfaces of the back yokes of the pole pieces do not appropriately come into contact with each other. Thus, dimension accuracy of the stator is degraded.

The specification provides a technique of preventing degradation of dimension accuracy of a stator in a case where the stator is formed by being transformed into a tubular state, in which partial cores in a core body is arranged in the tubular shape, from an opened state, in which the partial cores are opened.

The technique disclosed herein relates to a brushless motor. The brushless motor may comprise a stator and a rotor. The rotor may be disposed to face the stator. The stator may comprise a core body and a coil wire. The core body may comprise a plurality of partial cores. The coil wire may be wound around each partial core. Each partial core may comprise a yoke, teeth and a connector. The yoke may be positioned on an outer edge of the stator. The teeth, around which the coil wire is wound, may extend towards the rotor from the yoke and comprising a surface facing the rotor. The connector may extend to an adjacent partial core from the yoke, to be connected to the yoke of the adjacent partial core. The stator may be formed to be in a tubular state, in which the partial cores are arranged in a tubular shape, by being transformed from an opened state, in which the partial cores are opened, by bending the connector of each of the partial cores. Each of the yokes of the partial cores may comprise a facing surface facing the yoke of the adjacent partial core, on an edge portion in a circumferential direction of the stator. At least one set of the facing surfaces among a plurality of sets of the facing surfaces facing each other may be disposed with a gap in between in the circumferential direction of the stator. Rest of the sets of the facing surfaces facing each other may be in contact with each other in the circumferential direction of the stator.

With this configuration, when a dimension of the core body in the opened state varies among the stators, variation is offset by narrowing and widening the gap between at least one pair of the facing surfaces. As a result, the degradation of the dimension accuracy of the stator may be prevented.

### BRIEF DESCRIPTION OF DRAWINGS

FIG. 1 shows a longitudinal cross-sectional view of a fuel pump. FIG. 2 shows a cross-sectional view of a stator along line II-II in FIG. 1 of a first embodiment. FIG. 3 shows a plan view of the stator in an opened state of the first embodiment. FIG. 4 shows a cross-sectional view of the stator in the opened state along line II-II in FIG. 1 of the first embodiment. FIG. 5 shows a cross-sectional view of the stator in the opened state along line II-11 in FIG. 1 of a modification of the first embodiment. FIG. 6 shows a cross-sectional view of the stator in the opened state along line 1141 in FIG. 1 of a modification of the first embodiment. FIG. 7 shows a plan view of the stator in the opened state of a second embodiment. FIG. 8 shows a cross-sectional view of the stator along line II-11 in FIG. 1 of the second embodiment. FIG. 9 shows a plan view of the stator in the opened state of a third embodiment. FIG. 10 shows a cross-sectional view of the stator alone line 1141 in FIG. 1 of the third embodiment. FIG. 11 shows a cross-sectional view of a stator along line II-II in FIG. 1 of a modification.

### DETAILED DESCRIPTION

Some of main features of embodiments described herein will be listed. Notably, technical features described herein are each independent technical element, and exhibit technical usefulness thereof solely or in combinations.

(Feature 1) A length around an outer circumference of the stator may be longer than a sum of lengths of outer circumference portions of the yokes of the partial cores and lengths of the connectors in the opened state. The outer circumference portions may correspond to an outer circumference of the stator. With this configuration, the stator may be easily manufactured.

(Feature 2) The at least one set of the facing surfaces disposed with the gap in between in the circumferential direction of the stator may be in contact with each other in a direction towards an outer circumference of the stator from a rotational center of the rotor. With this configuration, the pair of partial cores, respectively comprising the facing surfaces disposed with the gap in between, may be positioned relative to each other in the direction towards the outer circumference of the stator from the rotational center of the rotor.

(Feature 3) The brushless motor may be a three-phase AC motor comprising 3×N slots. N may be a positive integer. The partial cores may be each in any one of N core groups each comprising three partial cores respectively corresponding to three phases. The three partial cores may be continuously arranged in each of the core groups. One set of facing surfaces positioned between two adjacent ones of the core groups may be disposed with a gap in between in the circumferential direction of the stator. With this configuration, a magnetic circuit of the yoke is formed by the three partial cores in each of the core groups. As a result, the brushless motor may exert characteristics similar to those of the brushless motor having a configuration with no gap between the facing surfaces.

(Feature 4) Two sets of facing surfaces of the three partial cores in each of the core groups may be each in contact with each other, in the circumferential direction of the stator. With this configuration, magnetic resistance between the yokes of the adjacent partial cores in the core group may be reduced.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved brushless motors, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

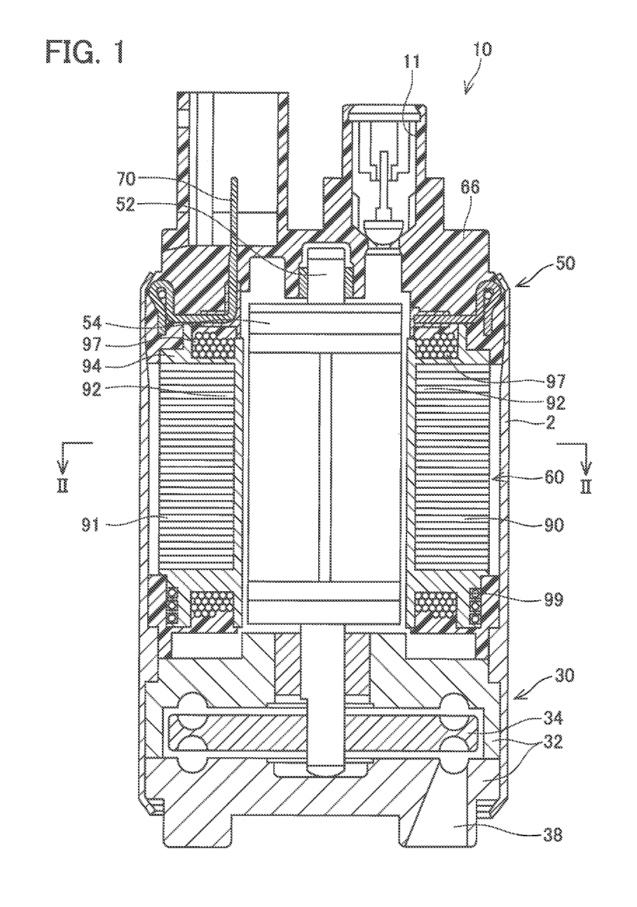

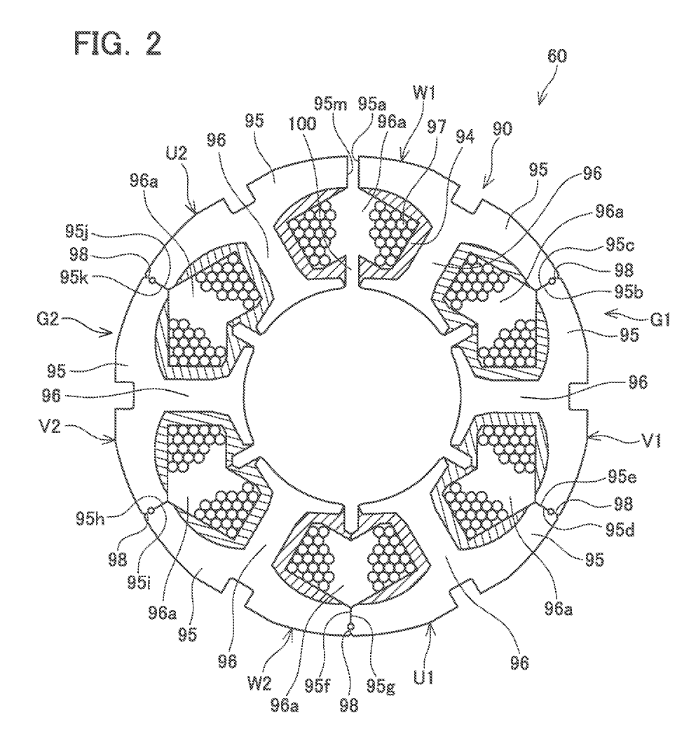

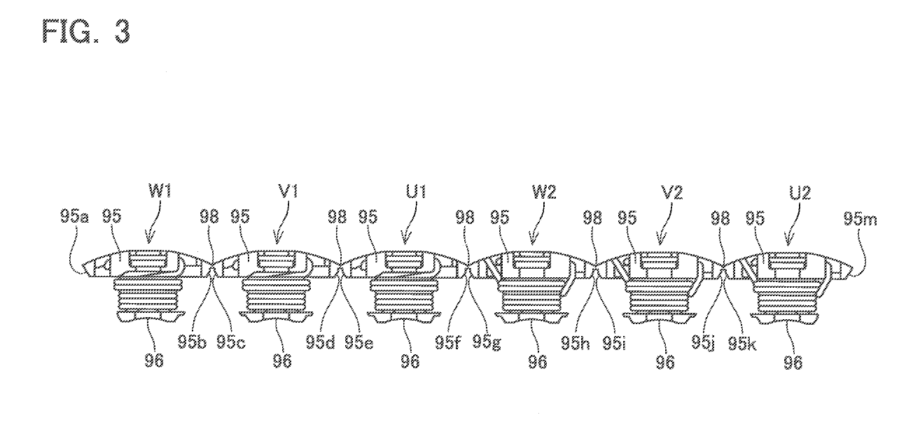

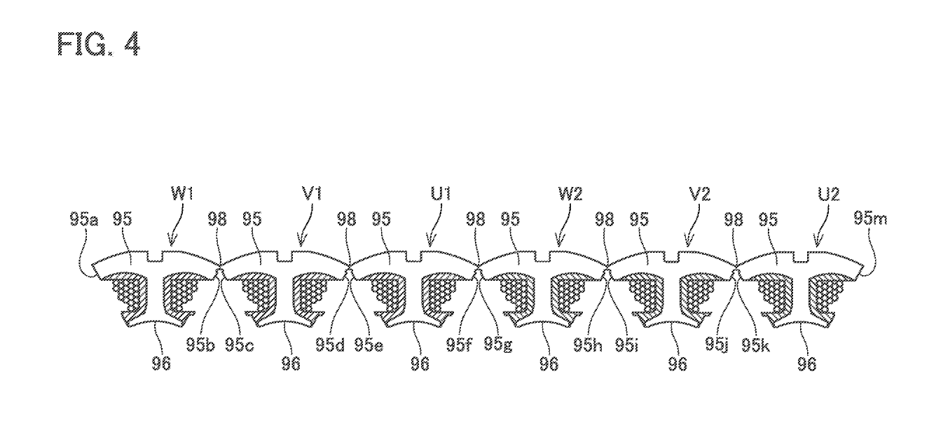

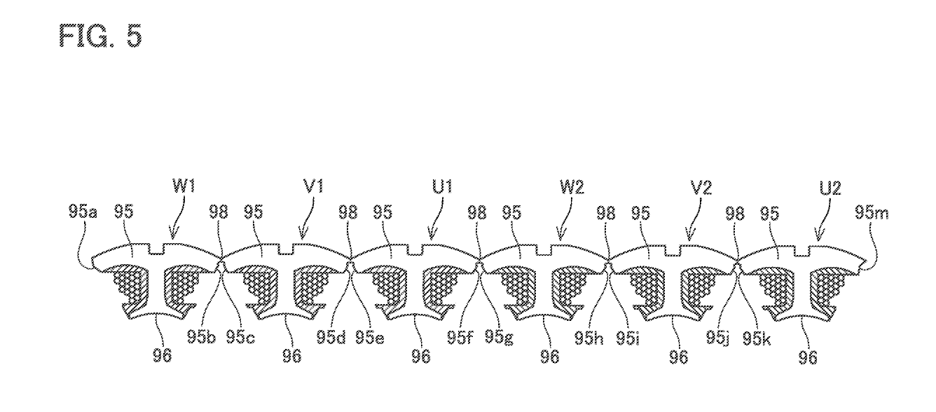

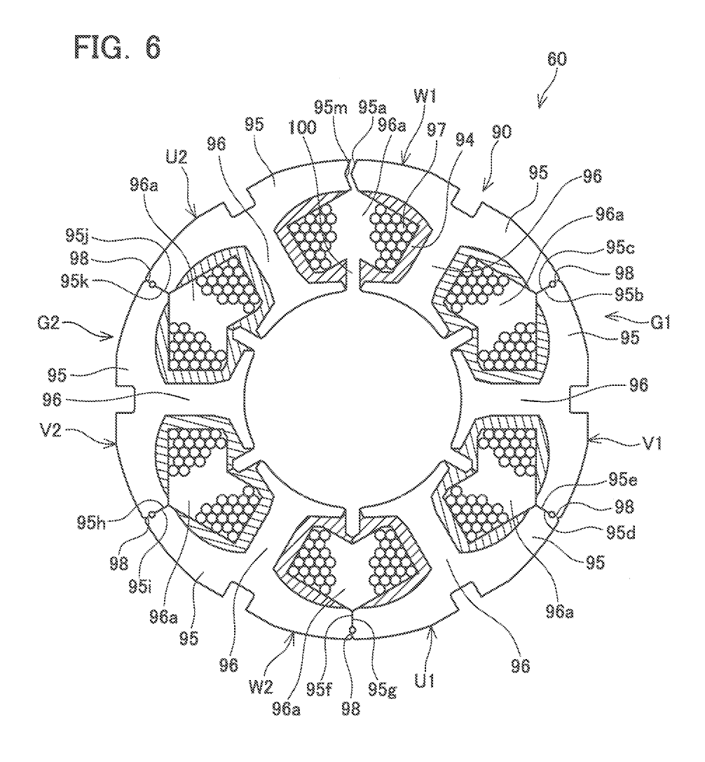

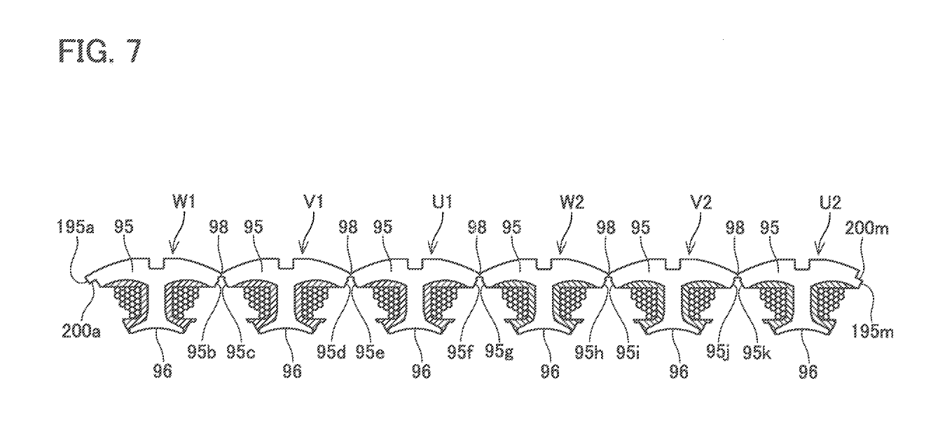

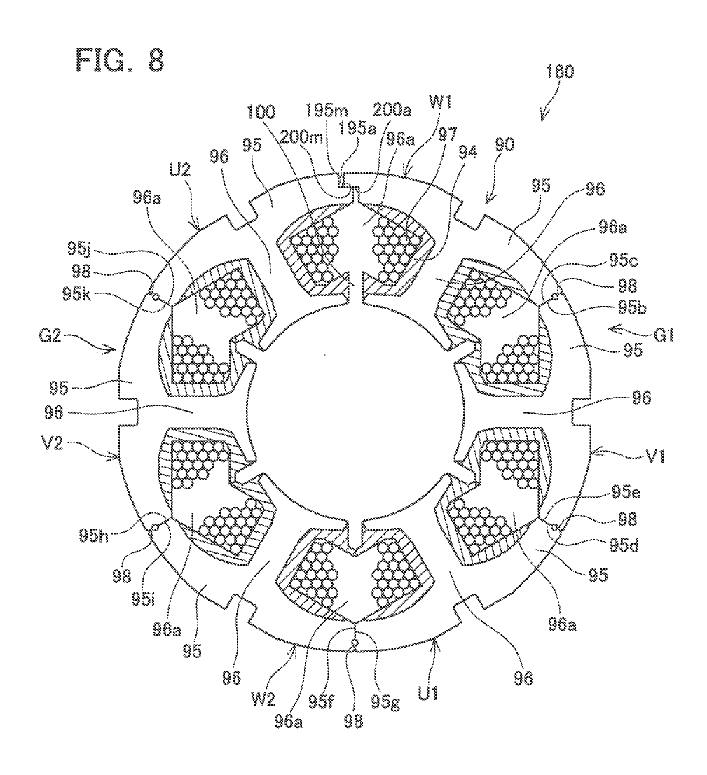

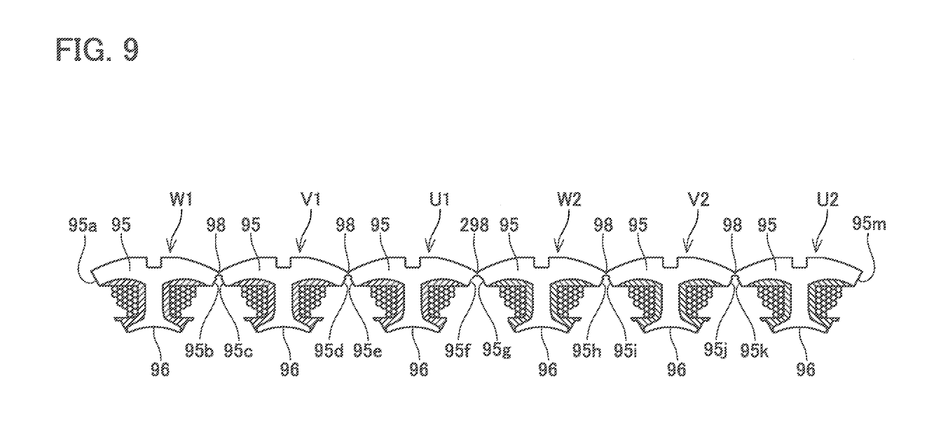

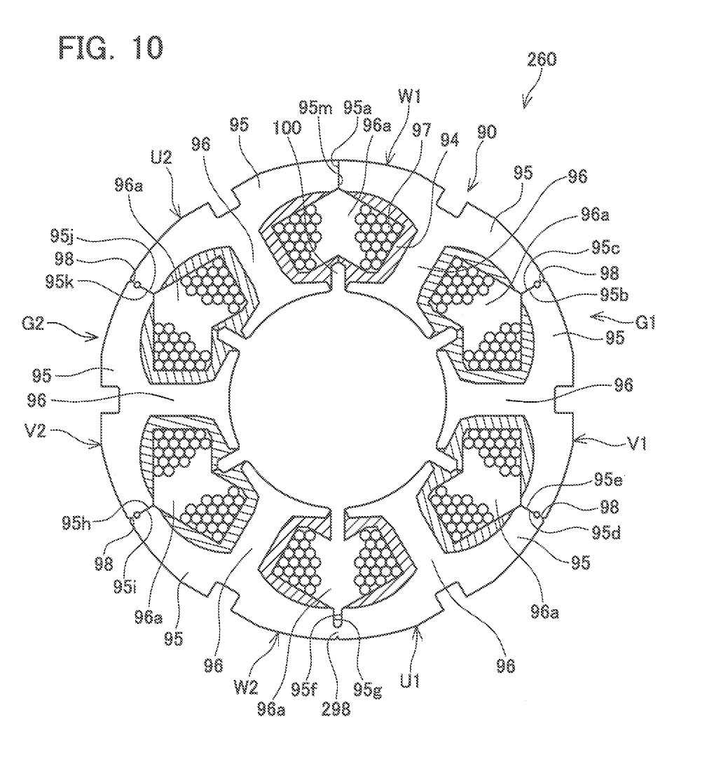

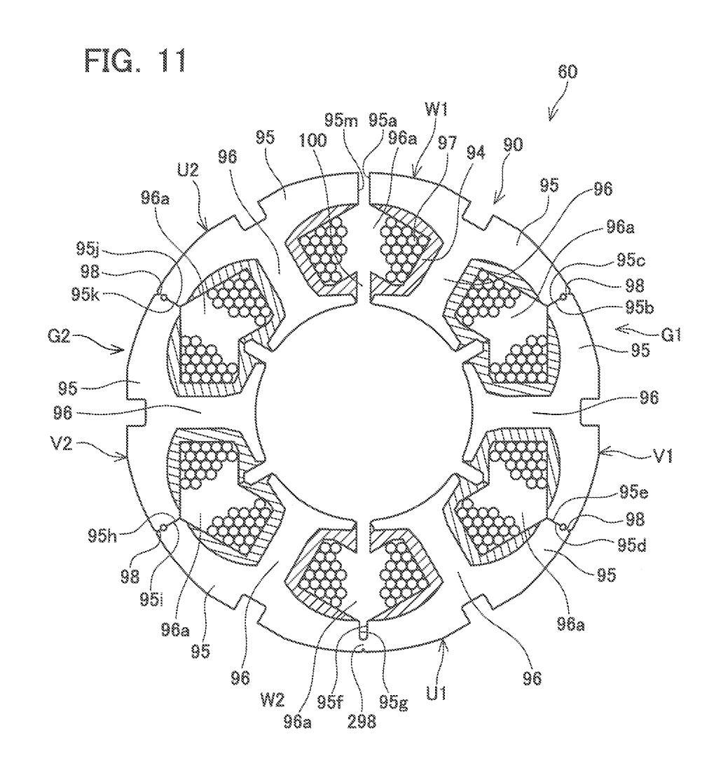

As shown in FIG, 1, a motor portion 50 of the present embodiment is used for a fuel pump 10. The fuel pump 10 is disposed in a fuel tank (not illustrated), and supplies fuel (gasoline, for example) to an engine (not illustrated) of an automobile. As shown in FIG. 1, the fuel pump 10 comprises a pump portion 30, in addition to the motor portion 50. The motor portion 50 and the pump portion 30 are disposed in a housing 2. The housing 2 has a tubular shape with both ends opened.

The pump portion 30 comprises a easing 32 and an impeller 34. The casing 32 closes an opening of a lower edge of the housing 2. At the lower edge of the casing 32, an intake port 38 is provided. At an upper edge of the casing 32, a through-hole (not shown) for communicating between an inside of the casing 32 and the motor portion 50 is provided. The impeller 34 is provided within the casing 32.

The motor portion 50 is positioned above the pump portion 30. The motor portion 50 is a brushless motor. The motor portion 50 is a three-phase motor. The motor portion 50 comprises a rotor 54 and a stator 60. The rotor 54 comprises a permanent magnet. At a center of the rotor 54, a shaft 52 is fixed by penetrating the rotor 54. A lower edge of the shaft 52 is inserted into a center portion of the impeller 34, and penetrates the impeller 34. The rotor 54 is rotatably supported around the shaft 52 by bearings disposed at both edge portions of the shaft 52. In the embodiment, above and below are stipulated in a state of FIG. 1. That is, the pump portion 30 is positioned “below”, viewed from the motor portion 50, and the motor portion 50 is positioned “above”, viewed from the pump portion 30.

The stator 60 is covered by a resin layer 66. The resin layer 66 closes an opening at the upper edge of the housing 2. At the upper edge of the resin layer 66, a discharge port 11 is provided. The discharge port 11 establishes a communicated state between the motor portion 50 and a fuel path outside the fuel pump 10. The discharge port 11 is an opening for discharging the fuel boosted by the pump portion 30 to the fuel path. The resin layer 66 has a portion covering the stator 60 and the discharge port 11 integrally formed of resin. The portion covering the stator 60 and the discharge port 11 may also be provided separately from each other.

The stator 60 comprises a core body 90, coil wires 97, and a terminal 70. In FIG. 1, a cross section of the core body 90 is omitted. The terminal 70 is attached to the upper edge of the stator 60. The terminal 70 is connected to a battery through a control circuit (the battery and the control circuit are not illustrated). The terminal 70 supplies electric power to the coil wires 97 of the stator 60.

The core body 90 comprises a group of core plates 92 and an insulator 94 disposed on a surface of the group of core plates 92. The group of core plates 92 comprises a plurality of core plates 92. The core plates 92 are laminated in a vertical direction. Each core plate 92 is formed of a magnetic material. The insulator 94 is formed of an insulating resin material. The insulator 94 covers the surface of the group of core plates 92 comprising the laminated core plates 92.

As shown in FIG. 2, the core body 90 comprises six partial cores U1, V1, W1, U2, V2, and W2. The six partial cores U1 to W2 comprise two U-phase partial cores U1 and U2, two V-phase partial cores V1 and V2, and two W-phase partial cores W1 and W2. The coil wire 97 is wound around each of the partial cores U1 to W2. Specifically, the coil wire 97 wound around the partial core U1 is guided through a guide groove 99 (see FIG. 1) to the partial core U2, to be wound around the partial core U2. Similarly, the coil wire 97 wound around the partial core V1 is wound around the partial core V2, and the coil wire 97 wound around the partial core W1 is wound around the partial core W2. Thus, the partial cores U1 and U2 correspond to U-phase, the partial cores V1 and V2 correspond to V-phase, and the partial cores W1 and W2 correspond to W-phase. The partial cores U1, V1, and W1 are each a core from which winding of the coil wire 97 starts, and the partial cores U2. V2, and W2 are each a core at which the winding of the coil wire 97 ends.

Next, the partial cores U1 to W2 are described. The partial cores U1 to W2 have approximately the same configuration. Thus, the partial core W1 is first described, and for the other partial cores U1, and V1 to W2, only points different from the partial core W1 are described. The partial core W1 comprises a yoke 95, teeth 96, and a connector 98.

The yoke 95 is positioned on a most outer circumferential side of the partial core W1. The yoke 95 has an are shape. The yoke 95 comprises facing surfaces 95a and 95b on both ends of the stator 60 in circumferential directions. The facing surfaces 95a and 95b respectively faces yokes 95 of the respective adjacent partial cores U2 and V1. The facing surface 95a faces a facing surface 95m of the yoke 95 of the adjacent partial core U2 with a gap in between. The facing surface 95b is in contact with the facing surface 95c of the yoke 95 of the adjacent partial core V1. The facing surface 95b and the facing surface 95c are in contact with each other, over their entire surfaces.

The yoke 95 comprises the connector 98 positioned more on the outer circumferential side than the facing surface 95b. The connector 98 is connected to the yoke 95 of the partial core W1 and the yoke 95 of the partial core V1, and thus connects the partial core W1 with the partial core V1. The yoke 95 of the partial core W1 is not connected to the yoke 95 of the partial core U2 through a connector.

The teeth 96 extending towards a center of the stator 60 are disposed in a center portion of the yoke 95. A gap is provided between the teeth 96 and the teeth 96 of each of the adjacent partial cores U2 and V1, and a single slot 96a is formed in the gap. In the partial cores U1 to W2, the slot 96a is formed between the teeth 96 of one of the partial cores U1 to W2 and the teeth 96 of the adjacent one of the partial cores U1 to W2. Thus, the motor portion 50 comprises six slots 96a. A distal end of the teeth 96 on an inner circumferential side of the stator 60 faces the rotor 54 and has a shape corresponding to the shape of an outer circumferential surface of the rotor 54. The coil wire 97 is wound around an intermediate portion of the teeth 96 with the insulator 94 disposed in between.

A difference between the partial cores U1, V1, and U2 to W2 and the partial core W1 will be described. The facing surface 95e of the partial core U1 is in contact with the facing surface 95d of the adjacent partial core V1. A facing surface 95f of the partial core U1 is in contact with a facing surface 95g of the adjacent partial core W2. Similarly, a facing surface 95h of the partial core W2 is in contact with a facing surface 95i of the adjacent partial core V2. A facing surface 95j of the partial core V2 is in contact with a facing surface 95k of the adjacent partial core U2. Thus, in the stator 60, one set of the facing surfaces (95a and 95m), of the six pairs of facing surfaces facing each other, are disposed with a gap in between in the circumferential direction of the stator 60. Each of the entire surfaces of the other sets of the facing surfaces (95b and 95c), (95d and 95e), (95f and 95g), (95h and 95i), and (95j and 95k), other than the one set of the facing surfaces (95a and 95m), is in contact with each other in the circumferential direction of the stator 60.

The six partial cores U1 to W2 are connected with each other by the connectors 98 on the outer circumferential side of the stator 60. The stator 60 before being accommodated in the housing 2 can be switched between an opened state (a state shown in FIGS. 3 and 4) and a tubular state (a state shown in FIG. 2) by bending the connectors 98. In the opened state, the six partial cores U1 to W2 are opened to be linearly arranged. In the tubular state, the six partial cores U1 to W2 are bent into a tubular shape. Specifically, in the opened state shown in FIGS. 3 and 4, the six partial cores U1 to W2 are linearly arranged with the adjacent partial cores (W1 and V1), (V1 and U1), (U1 and W2), (W2 and V2), and (V2 and U2) connected with each other by the connectors 98 on the outer circumferential side. With the partial cores U1 to W2 linearly arranged, the coil wire 97 can be easily wound around each of the partial cores U1 to W2.

In the tubular state shown in FIG. 2, of adjacent partial cores (W1 and V1), (V1 and U1), (U1 and W2), (W2 and V2), (V2 and U2), and (U2 and W1), each of the adjacent partial cores (W1 and V1), (V1 and U1), (U1 and W2), (W2 and V2), and (V2 and U2), other than the partial cores U2 and W1 positioned at both ends in the opened state, are in close contact with each other at the facing surfaces (95b and 95c),(95d and 95e),(95f and 95g),(95h and 95i), and (95j and 95k). The adjacent partial cores (U2 and W1) are disposed with the gap in between. As a result, a length around the outer circumferential surface of the stator 60 in the tubular state is longer than a sum of the lengths of portions, of the yokes 95 of the partial cores U1 to W2, corresponding to an outer circumference of the stator 60, and the lengths of the connectors 98, in the opened state, that is, a length of an upper edge line in FIG. 4.

In this configuration, when the dimension of the stator 60 in the opened state is larger than a planned dimension, a dimensional error can be offset by narrowing the gap between the facing surfaces 95a and 95m. Thus, the stator 60 can be manufactured to have the planned dimension, even, when the dimension of the stator 60 in the opened state is larger than the planned dimension. Thus, degradation of dimension accuracy of the stator 60 can be prevented. The adjacent partial cores (U2 and W1) are not connected with each other by the connector. Thus, the gap between the facing surfaces 95a and 95m can be easily adjusted. Thus, even when the dimension of the stator 60 in the opened state varies among the products, the stators 60 in the tubular state can be prevented from having different dimensions.

When transforming the stator 60 from the opened state to the tubular state, the connectors 98 may bent until the facing surfaces 95a and 95m come into contact with each other, for example, so that the connectors 98 are subjected to further bending than the connectors 98 in the tubular state, in anticipation of spring back of the connectors 98. Thus, the facing surfaces (95b and 95c), (95d and 95e), (95f and 95g), (95h and 95i), and (95j and 95k) can be in more close contact with each other, whereby magnetic resistance of the magnetic circuit formed in the stator 60 can be reduced.

Next, how the fuel pump 10 is driven will be described. When three-phase AC current is supplied to the coil wires 97 in the fuel pump 10 through the terminal 70, a rotating magnetic field is generated in the stator 60, whereby the rotor 54 is rotated. Thus, the fuel pump 10 pumps the fuel in the fuel tank to the engine.

The gap between the facing surfaces 95a and 95m is positioned between a core group G1 and a core group G2. The core group 01 comprises the partial cores U1, V1, and W1 respectively corresponding to U, V, and W phases. The core group G2 comprises the partial cores U2, V2, and W2 respectively corresponding to U, V, and W phases. The magnetic field is generated in the core body 90 while the three-phase AC current is supplied to the coil wires 97. Lines of magnetic flux passing through the yoke 95 pass through the facing surfaces in contact with each other to reach the yoke 95 of the adjacent partial core. However, in the adjacent partial cores (U2 and W1), the pair of facing surfaces (95a and 95m) has the gap in between, and thus the lines of magnetic flux do not pass therebetween. Thus, in the stator 60, the core group G1 forms a single magnetic circuit, and the core group G2 forms another single magnetic circuit separated from the magnetic circuit of the core group G1. As a result, even when the pair of facing surfaces (95a and 95m) has a gap in between, the motor portion 50 can exert motor characteristics (rotation speed and motor efficiency, for example) similar to a case where the pair of facing surfaces (95a and 95m) has no gap in between.

In each of the core groups G1 and G2, the adjacent partial cores in each of the core groups G1 and G2 are in contact with each other at the pair of facing surfaces. With this configuration, the magnetic resistance of the magnetic circuit formed in each of the core groups G1 and G2 can be reduced.

### Modification of First Embodiment

The facing surfaces 95a and 95m need not to be flat surfaces. For example, as shown in FIG. 5, the facing surface 95a of the partial core W1 may have a shape protruding in a circumferential direction of the stator 60. The facing surface 95m of the partial core U2 may have a shape recessed in the circumferential direction of the stator 60, in accordance with the facing surface 95a. As shown in FIG. 6, when the stator 60 of this modification is transformed to the tubular state from the opened state, the facing surface 95a is inserted into the facing surface 95m. In this configuration, the facing surfaces 95a and 95m, that is, the partial cores W1 and U2, can be easily positioned.

### Second Embodiment

Compared with the first embodiment, in this embodiment, a configuration of a stator 160 is different from that of the stator 60. The difference from the first embodiment is described. As shown in FIG. 7, in this embodiment, a facing surface 195a of the partial core W1 and a facing surface 195m of the partial core U2 are respectively different from the facing surfaces 95a and 95m, in shape. The configuration of the stator 160 other than this is similar to the configuration of the stator 60.

The facing surface 195a protrudes in the circumferential direction of the stator 160 on the outer circumferential side of the stator 160. An inner circumferential surface 200a of a protruded portion of the facing surface 195a has an arc surface concentric with respect to the outer circumferential surface of the stator 160. The facing surface 195m protrudes in the circumferential direction of the stator 160 on an inner circumferential side of the stator 160. An outer circumferential surface 200m of a protruded portion of the facing surface 195m has the arc surface concentric with respect to the outer circumferential surface of the stator 160.

As shown in FIG. 8, when the stator 160 of this embodiment is transformed to the tubular state from the opened state, the inner circumferential surface 200a comes into contact with the outer circumferential surface 200m. Thus, the partial cores W1 and U2 can be easily positioned. The magnetic circuit formed by the core group G1 can be connected to the magnetic circuit formed by the core group G2.

In this modification, a configuration, in which the facing surfaces 195a and 195m engage with each other, may be employed. With this configuration, the stator 160 can be maintained in the tubular state.

### Third Embodiment

Compared with the first embodiment, in this embodiment, a configuration of a stator 260 is different from the configuration of the stator 60. The difference from the first embodiment is described, As shown in FIG. 9, in this embodiment, a connector 298 of the partial core U1, that is, the connector 298 connecting the partial core U1 with the partial core W2, is longer than the connector 98 of the partial core U1 of the first embodiment.

As shown in FIG. 10, when the stator 260 of this embodiment is transformed to the tubular state from the opened state, the pair of facing surfaces (95a and 95m) comes into contact with each other, whereas the pair of facing surfaces (95f and 95g) is disposed with a gap in between. The configuration of the stator 260 other than this is similar to the configuration of the stator 60.

With this configuration, the connector 298 is compressed or expanded in the circumferential direction of the stator 260. Thus, the shape of the stator 260 in the tubular state can be easily adjusted. When the connector 298 is not compressed or expanded in the circumferential direction of the stator 260, the length around the outer circumferential surface of the stator 260 in the tubular state is the same as the sum of the lengths of the portions, of the yokes 95 of the partial cores U1 to W2, corresponding to the outer circumference of the stator 260 and lengths of the connectors 98 and 298, in the opened state, that is, the length of the upper edge line in FIG. 9.

### Modifications

(1) The embodiments described above are an example where the stator is used for the fuel pump 10. Alternatively, the brushless motor disclosed in this specification may he used for an electric pump such as a cooling water pump, or other devices.

(2) In the embodiments described above, one set of facing surfaces of a plurality of sets of facing surfaces is disposed with a gap in between. Alternatively, two or more sets of facing surfaces may be disposed with a gap in between. For example, as shown in FIG. 11, the stator 60 of the first embodiment may be combined with the stator 260 of the third embodiment. Specifically, each of two sets of facing surfaces (95 and 95m) and (95f and 95g) may be disposed with a gap in between. The partial cores U1 and W2 may be connected with each other by the connector 298.

(3) In the embodiments described above, the motor portion 50 as the three-phase motor comprising the six slots is described. Alternatively, the motor may be a three-phase AC motor comprising 3×N slots. N may be a positive integer. Here, the stator may comprise 3×N partial cores. Here, the 3×N partial cores may be classified into N core groups. Three partial cores in each core group may be arranged in the circumferential direction of the stator. The three partial cores in a single core group may have facing surfaces in contact with each other. At least one set of facing surfaces, of the facing surfaces positioned between the core groups, may be disposed with a gap in between. One set of facing surfaces of adjacent partial cores in the same core group may be disposed with a gap in between.

(4) In the embodiments described above, the connector 98 for the adjacent partial cores is disposed on an outer circumferential edge of the facing surface. Alternatively, the connector 98 may be disposed at a position different from the outer circumferential edge of the facing surface, such as an inner circumferential edge or a center position of the facing surface, for example.

What is claimed is:

1. A brushless motor comprising:
a stator; and
a rotor disposed to face the stator, wherein the stator comprises:
a core body comprising a plurality of partial cores; and
a coil wire wound around each partial core,
each partial core comprises:
a yoke positioned on an outer edge of the stator;
teeth, around which the coil wire is wound, extending towards the rotor from the yoke and comprising a surface facing the rotor; and
a connector extending to an adjacent partial core from the yoke, to be connected to the yoke of the adjacent partial core,
the stator is formed to be in a tubular state, in which the partial cores are arranged in a tubular shape, by being transformed from an opened state, in which the partial cores are opened, by bending the connector of each of the partial cores,
each of the yokes of the partial cores comprises a facing surface facing the yoke of the adjacent partial core, on an edge portion in a circumferential direction of the stator,
at least one set of the facing surfaces among a plurality of sets of the facing surfaces facing each other is disposed with a gap in between in the circumferential direction of the stator, and
rest of the sets of the facing surfaces facing each other are in contact with each other in the circumferential direction of the stator.

2. The brushless motor according to claim 1, wherein
a length around an outer circumference of the stator is longer than a sum of lengths of outer circumference portions of the yokes of the partial cores and lengths of the connectors in the opened state, and
the outer circumference portions correspond to an outer circumference of the stator.

3. The brushless motor according to claim l, wherein
the at least one set of the facing surfaces disposed with the gap in between in the circumferential direction of the stator is in contact with each other in a direction towards an outer circumference of the stator from a rotational center of the rotor.

4. The brushless motor according to claim 1, wherein
the brushless motor is a three-phase AC motor comprising 3×N slots, N being a positive integer,
the partial cores are each in any one of N core groups each comprising three partial cores respectively corresponding to three phases,
the three partial cores are continuously arranged in each of the core groups, and
one set of facing surfaces positioned between two adjacent ones of the core groups is disposed with a gap in between in the circumferential direction of the stator.

5. The brushless motor according to claim 4, wherein
two sets of facing surfaces of the three partial cores in each of the core groups are each in contact with each other, in the circumferential direction of the stator.
